(19) United States
(12) Patent Application Publication
(10) Pub. No.: US 2006/0043220 A1
(43) Pub. Date: Mar. 2, 2006

(54) Gaseous fuel injector

(76) Inventor: Samuel Leroux, Poissy (FR)

Correspondence Address: FOLEY & LARDNER LLP, 777 EAST WISCONSIN AVENUE, SUITE 3800, MILWAUKEE, WI, 53202-5308, US

(21) Appl. No.: 10/523,453

(22) PCT Filed: Jul. 30, 2003
(86) PCT No.: PCT/FR03/02419

§ 371 Date: Jan. 28, 2005

(30) Foreign Application Priority Data
Jul. 30, 2002 (FR) 02/09664

(51) Int. Cl. F02M 51/00

(52) U.S. Cl. 239/585.1

(57) ABSTRACT

An injector for gaseous fuel, the injector comprising a body provided with a fuel feed duct and with a fuel delivery duct, the fuel feed duct and the fuel delivery duct opening out into a chamber of the body in which there are mounted a valve member and an actuator means for actuating the valve member between a closed position and an open position in which the valve member defines a fuel flow section, wherein the fuel delivery duct comprises a calibrated segment of section smaller than the flow section defined by the valve member when in the open position.

### CROSS REFERENCE TO RELATED APPLICATIONS

This application is a National Stage of application PCT/FRO3/02419, filed Jul. 30, 2003, and claims priority to French patent application 02 09664 filed Jul. 30, 2002, the disclosures of which are incorporated herein by reference in their entirety.

### FIELD

The present invention relates to a fuel injector. The fuel injector may be used with gaseous fuel. The fuel injector may be suitable for use in single- or dual-carburetion engines running on liquefied petroleum gas (LPG) or the like.

In this application, the injector may serve to introduce gaseous fuel at a determined flow rate into a combustion chamber of the engine.

### BACKGROUND

An injector for gaseous fuel generally comprises a body provided with a fuel feed duct, and with a fuel delivery duct for delivering fuel from the injector. The fuel feed duct and the fuel delivery duct each generally has a first end opening out to the outside of the body for connection to the fuel tank and the combustion chamber of the engine, respectively, and a second end opening out into a chamber of the body having mounted therein a valve member and means for actuating the valve member between a closed position in which the valve member is pressed against the second end of the fuel delivery duct, and an open position in which the valve member is spaced apart from the second end of the fuel delivery duct in order to define a fuel flow section. This fuel flow section is generally cylindrical in shape and of area equal to the product of the circumference of the second end of the fuel delivery duct multiplied by the distance between the second end of the fuel delivery duct and the valve member when in the open position. This distance corresponds to the stroke of the valve member. The fuel flow section as defined in this way defines the flow rate with which fuel is delivered to the combustion chamber, and must therefore be precise since it influences the performance of the engine.

Unfortunately, the stroke of the valve member depends on the dimensions of the valve member itself and of certain components of the actuator means, and also on the clearances that exist between these various elements. The accuracy of the stroke thus depends on the quality of the machining and on the quality of the assembly of the various elements, thus making manufacture of the injector difficult. In addition, the effects of temperature, shocks, vibration, and general wear all lead to changes (which are only temporary for temperature) to the dimensions and the clearances defining the stroke, such that the fuel flow section and the delivery flow rate do not remain constant over time. Thus, there is a need to have an injector capable of delivering fuel without unexpected variations in the delivery flow rate.

### SUMMARY

One embodiment is directed to an injector for gaseous fuel, the injector comprising a body comprising a fuel feed duct and a fuel delivery duct, the fuel feed duct and the delivery duct opening out into a chamber of the body in which there are mounted a valve member, and an actuator means for actuating the valve member between a closed position and an open position in which the valve member defines a fuel flow section, wherein the fuel delivery duct comprises a calibrated segment of section smaller than the fuel flow section defined by the valve member when in the open position. The section of the calibrated segment determines the delivery flow rate independent of the stroke of the valve member.

This embodiment may provide an injector capable of delivering fuel without unexpected variations in flow rate.

Other characteristics and advantages of the invention appear on reading the following description of a particular and non-limiting embodiment of the invention.

### BRIEF DESCRIPTION OF THE DRAWINGS

FIG. 1 is a diagrammatic section view of an injector in accordance with one embodiment, the valve member being in its closed position.

FIG. 2 is a fragmentary diagrammatic view in section of an injector, the valve member being in its open position.

### DETAILED DESCRIPTION

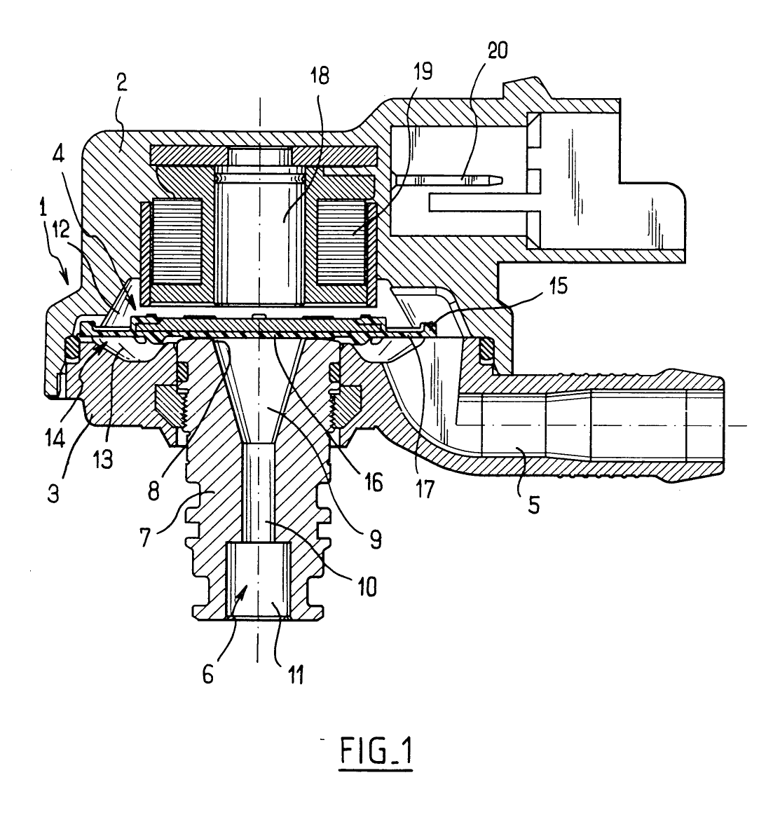

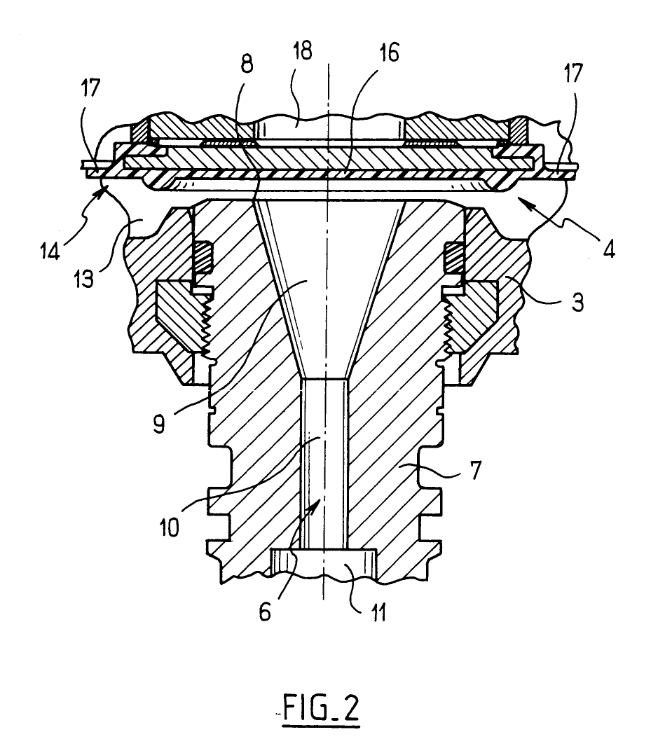

With reference to FIG. 1 and FIG. 2, the injector in accordance with an embodiment comprises a body 1 comprised of a top half-body 2 and a bottom half-body 3 that are fastened to one another.

The top half-body 2 and the bottom half-body 3 define between them a chamber into which there opens out a fuel feed duct 5 and a fuel delivery duct 6.

The fuel feed duct 5 is formed in the bottom half-body 3 and has a first end that opens to the outside of the body 1 for connection to the fuel tank of a motor vehicle, and a second end that opens out into the chamber 4.

The fuel delivery duct 6 is formed in an endpiece 7 mounted on the bottom half-body 3 so that the fuel delivery duct 6 has a first end that opens to the outside the body 1 for connection to the combustion chamber of an engine, and a second end that opens out via an opening 8 into the chamber 4.

The fuel delivery duct 6 has a frustoconical segment 9 extending from the opening 8 to a calibrated segment 10, tapering towards the calibrated segment 10, followed by a terminal segment 11 which is connected to the calibrated segment 10.

The frustoconical segment 9 has an angle of less than 55° at the angle of the frustoconical segment 9. The frustoconical segment 9 could have an angle of any suitable number of degrees at its apex, including, but not limited to substantially equal to 40°. A suitable number of degrees for the angle at the apex of the frustoconical segment is one that limits disturbances of flow rate in the frustoconical segment 9.

The calibrated segment 10 comprises a section which is designed to correspond to the delivery rate that is to be supplied by the injector. The terminal segment 11 is of section that is not less than that of the calibrated segment 10.

The fuel delivery duct 6 is also arranged to ensure that the flow speed of the fuel in the calibrated segment 10 is sonic. In this way, a delivery flow rate is obtained that is substantially constant in spite of variations in the pressure downstream from the calibrated segment 10.

The chamber 4 is subdivided into a top compartment 12 and a bottom compartment 13, wherein the top compartment 12 is located above the bottom compartment 13. The chamber 4 is subdivided into the top compartment 12 and the bottom compartment 13 by means of a diaphragm 14 which extends transversely to the axis of the fuel delivery duct 6 at the opening 8. The diaphragm 14 comprises a peripheral edge 15 held captive between the top half-body 2 and the bottom half-body 3, a central portion in register with the opening 8 in order to form a valve member 16, and an intermediate portion 17 connecting the peripheral edge 15 to the central portion 16. The intermediate portion 17 is elastically deformable so that the valve member 16 of the diaphragm 14 can move between a closed position (as illustrated in FIG. 1) in which the valve member 16 is pressed against the edge of the opening 8, and an open position (as illustrated in FIG. 2), in which the valve number 16 is spaced apart from the edge of the opening 8 and cooperates therewith to define a fuel flow section for the fuel. The fuel flow section can be any number of suitable shapes, including, but not limited to, cylindrical. The area of cylindrical fuel flow section can be equal to the product of the circumference of the opening 8 multiplied by the distance between the edge of the opening 8 and the valve number in the diaphragm 14. The circumference of the opening 8 and the distance between the edge of the opening 8 and the in the diaphragm 14 can be designed so that a cylindrical fuel flow section is greater than the section of the calibrated segment 10 so that the delivery rate is determined by the section of the calibrated segment 10 and not by the cylindrical fuel flow section.

The injector has means for actuating the valve member 16 in the diaphragm 14 to move between the open and closed positions of the valve member. These actuator means can be housed in the top compartment 12 of the chamber 4 and comprise a magnetic core 18 surrounded by a coil 19 associated with means providing a connection with an electrical power supply 20 (not shown). In order to improve return of the valve member 16 in the diaphragm 14 to the closed position of the valve member 16, a fraction of the fuel taken from the fuel feed duct 5 can be delivered into the top compartment 12 in order to establish a backing pressure therein. By way of example, and not be way of limitation, for an opening 8 comprised of a diameter of 8 millimeters (mm) and a diaphragm having a central portion 16 with a stroke of 0.3 mm, the calibrated segment 10 can have a diameter of about 2 mm.

Naturally, the invention is not limited to the embodiment described and variants can be applied thereto without going beyond the ambit of the invention as defined by the claims. The structure of the injector may be different from that described, and for example the bottom half-body 3 and the endpiece 7 may be constructed to be a single part. The actuator means may also be different and could, for example, incorporate mechanical means for returning the valve member 16 into its closed position. For example, the mechanical means can include, but is not limited to, a spring. The numerical values mentioned are given purely by way of example.

What is claimed is:

1. An injector for gaseous fuel, the injector comprising:
a body comprising:
a chamber of the body in which there is mounted a valve member and an actuator means for actuating the valve member between a closed position and an open position in which the valve member defines a fuel flow section
a fuel feed duct;
and a fuel delivery duct,
wherein the fuel feed duct and the fuel delivery duct open out into a chamber of the body,
wherein the fuel delivery duct comprises includes a calibrated segment of section smaller than the fuel flow section defined by the valve member when the valve member is in the open position.

2. An injector according to claim 1, wherein the fuel delivery duct comprises a frustoconical segment extending from the chamber to the calibrated section, tapering towards the calibrated section.

3. An injector according to claim 2, wherein the frustoconical segment has an angle at the apex of the frustoconical segment of less than about 55°.

4. An injector according to claim 1, wherein the fuel delivery duct is arranged to obtain a flow speed of fuel in the calibrated segment that is substantially sonic.

5. An injector according to claim 2 wherein the frustoconical segment has an angle at the apex of substantially 40°.

6. An injector according to claim 1, comprising:
a bottom half-body; and
an end piece mounted on the bottom half-body.

7. An injector according to claim 1, comprising a single part which comprises both a bottom half-body and an end piece.

8. An injector according to claim 1, wherein the actuator means comprises mechanical means.

9. An injector according to claim 8, wherein the mechanical means comprises a spring.

10. A fuel injector, the injector comprising:
a body comprising:
a chamber in which there is mounted,
a valve member, and
an actuator for actuating the valve member between a closed position and an open position, the valve member defining a fuel flow section when it is in the open position;
a fuel feed duct; and
a fuel delivery duct, the fuel delivery duct opening into the chamber;
wherein the fuel delivery duct comprises a calibrated segment of section smaller than the fuel flow section which is defined by the valve member when the valve member is in the open position.

11. An injector according to claim 10, wherein the fuel delivery duct is arranged to obtain a flow speed of fuel in the calibrated segment that is substantially sonic.

12. An injector according to claim 10, wherein the fuel delivery duct includes a frustoconical segment extending from the chamber to the calibrated section, tapering towards the calibrated section.

13. An injector according to claim 10 wherein the frustoconical segment has an angle at the apex of less than about 55°.

14. An injector according to claim 10 wherein the frustoconical segment has an angle at the apex of substantially 40°.

15. An injector according to claim 10 comprising:
a bottom half-body; and
an end piece mounted on the bottom half-body.

16. An injector according to claim 10 comprising a single part which comprises both a bottom half-body and an end piece.

17. An injector according to claim 10 wherein the actuator comprises a spring.

18. A fuel injector, comprising:
a body;
a valve associated with the body and having an open position, the valve member defining a fuel flow section when it is in the open position; and
a fuel delivery duct, the fuel delivery duct opening into the chamber and comprising a calibrated segment of section smaller than the fuel flow section.

19. A fuel injector, comprising:
a body; and
means for delivering fuel without unexpected variations in flow rate.

20. The injector of claim 19, wherein
the body comprises a chamber;
the injector further comprises a means for defining a fuel flow section, the means for defining a fuel flow section being arranged in the body; and
the means for delivering fuel without unexpected variations in flow rate comprises a means for delivering fuel to the chamber, the means for delivering fuel to the chamber being associated with the means for defining a fuel flow section.

21. The injector of claim 20, wherein the means for delivering fuel to the chamber comprises a frustoconical segment.
